(19) United States
(12) Patent Application Publication
(10) Pub. No.: US 2008/0306933 A1
(43) Pub. Date: Dec. 11, 2008

(54) DISPLAY OF SEARCH-ENGINE RESULTS AND LIST

(75) Inventors: JAMIL VALLIANI, SNOQUALMIE, WA (US); NITIN AGRAWAL, REDMOND, WA (US); DARINEE LOUVAU, REDMOND, WA (US); EYTAN D. SEIDMAN, SEATTLE, WA (US); LEI WANG, BELLEVUE, WA (US); YESHENG LI, BOTHELL, WA (US); DEQING CHEN, ISSAQUAH, WA (US); VIVEK J. JHAVERI, SEATTLE, WA (US); RAMEZ NAAM, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/760,492

(22) Filed: Jun. 8, 2007

(51) Int. Cl. G06F 17/30

(52) U.S. Cl. 707/5; 707/E17.108

(57) ABSTRACT

Displaying a list of search-engine results in the same web-browser window as a viewing frame that is configured to display one of the results is described herein. A user's web search is performed on a search engine, and results are returned to a client computing device. The results are listed in a web-browser window that is configured to simultaneously display any result selected by a user.

### BACKGROUND

The Internet is a worldwide system of interconnected computer networks that transmit data. The World Wide Web (Web) is an information space in which online documents called web pages are stored and published for the entire computing world to access. Anyone connected to the Internet can view the myriad of web pages available online by requesting global identifiers called Uniform Resource Identifiers (URIs) using a transfer protocol, such as the hypertext transfer protocol (HTTP). Once a user requests a URI, the user's web browser retrieves the corresponding web page and displays it on the user's computing device.

The wealth of information available on the Web spawned a specific type of web page called a search engine, which allows a user to locate web resources without knowledge of URIs. Popular examples of search engines include, MSN®, Yahoo!®, and Google®. Once a query is initiated by submitting search terms, a search engine returns a list of hyperlinks to web pages, or other web resources, that are related to the search terms. The user can then select results from the list to view. When a hyperlink is selected, the associated web page is displayed in the web browser.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments described herein generally relate to displaying a list of search-engine results in the same web-browser window as a viewing frame that is configured to display one of the results. A user interface displays a results page that contains multiple display areas. First, the results of a search-engine query are listed. Second, a viewing frame displays any of the results a user selects. Both are presented in the same web-browser window.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary operating environment for use in implementing an embodiment of the present invention;

FIG. 2 is a block diagram of a networking environment for use in implementing an embodiment of the present invention;

FIG. 3 is a flowchart illustrating a process for displaying a list of search-engine results in the same web-browser window as a presentation of one of the results, according to embodiments of the present invention; and

FIG. 4 is an exemplary display of a graphical user interface for displaying a list of search-engine results in the same web-browser window as a presentation of one of the results, according to embodiments of the present invention.

### DETAILED DESCRIPTION

The subject matter described herein is presented with specificity to meet statutory requirements. The description herein, however, is not intended to limit the scope of this patent. Rather, it is contemplated that the claimed subject matter might also be embodied in other ways, include different steps or combinations of steps similar to the ones described in this document, or be integrated with other present or future technologies. Although the term “block” may be used herein to connote different elements of methods employed, the term should not be interpreted as implying any particular order among or between various steps disclosed herein.

Embodiments described herein generally relate to presenting a list of search-engine results and the display of at least one of those results in the same web-browser window. In one embodiment, results of a search-engine query are displayed in a results page (i.e., a web page containing the retrieved results). When a user selects a listed result, the selected result is retrieved and presented in a viewing frame adjacent to the results list. Both the results list and the retrieved web resource are accessible in the same browser window, allowing the user to select other results in the list and see them in the viewing frame. As a result, the user can easily view each result in the list without having to leave the list of results.

A search-engine query, as discussed herein, refers to any keyword search of the Web by a search engine. Web-search queries may be initiated in any number of ways well known to those skilled in the art. For example, a user may enter keywords or phrases into a text field on a search engine's web page or into a text field of a web browser's tool bar. It will be apparent to those skilled in the art that numerous methods for initiating a search-engine query are also possible and need not be discussed at length herein. While embodiments discussed herein refer to accessing web pages via the Internet, other embodiments may access electronic documents via a private network.

Many conventional search engines allow users to focus web searches on particular types of web resources. Users can select options to only search news articles, web blogs, feeds, online spaces, and other types of online information. Typically, users select the focus of a search then submit keywords. The server executing the search engine will then query for resources of the particular type. As a result, only web resources that are relevant to the keywords and the particular type are returned. While many of the embodiments described herein refer to news-related searches, embodiments are not limited thereto. Rather, one skilled in the art will understand that the web searches described herein may be focused on any of the aforementioned types of web resources.

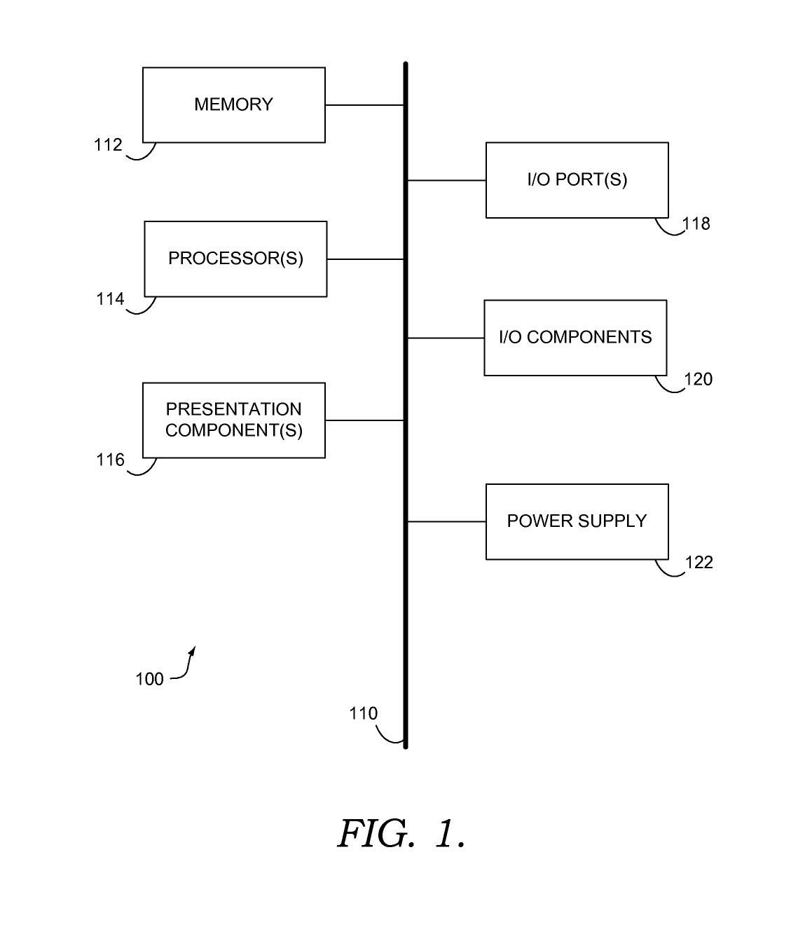

Having briefly described a general overview of the embodiments described herein, an exemplary operating environment is described below. Referring initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a personal computer. But in other embodiments, computing device 100 may be a cell phone, smartphone, digital phone, handheld device, BlackBerry®, personal digital assistant (PDA), or other device capable of executing computer instructions.

The invention may be described in the general context of computer code or machine-useable instructions, including computer-executable instructions such as program modules, being executed by a computer or other machine, such as a PDA or other handheld device. Generally, program modules including routines, programs, objects, components, data structures, and the like refer to code that perform particular tasks or implement particular abstract data types. Embodiments described herein may be practiced in a variety of system configurations, including hand-held devices, consumer electronics, general-purpose computers, more specialty computing devices, etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

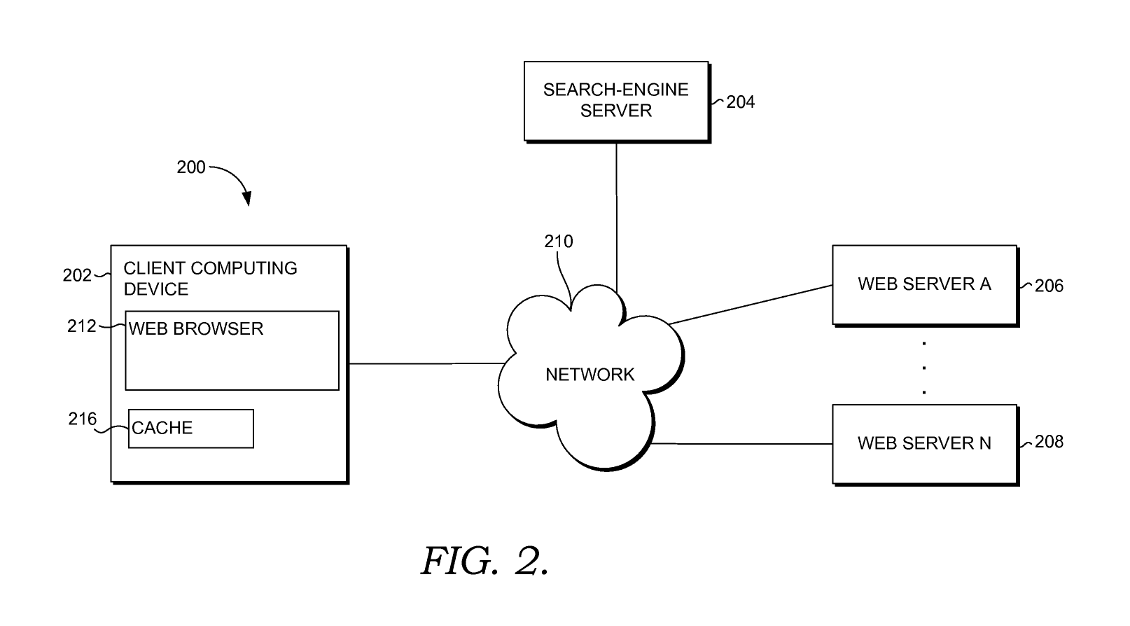

Turning now to FIG. 2, a block diagram depicting a networking architecture 200 is shown for use in implementing an embodiment of the present invention. The networking architecture 200 comprises a client computing device 202, search-engine server 204, and one or more web servers (indicated as a web server A 206 and a web server N 208), all of which communicate via network 210. The dots between the web server A 206 and the web server N 208 indicate that, in some embodiments, the number of web servers is scalable and may include any number of web servers accessible over the network 210. One skilled in the art will appreciate this concept, because web pages are typically hosted on different web servers, and different portions of a single web page may be hosted on different servers. Networking architecture 200 is merely an example of one suitable networking environment and is not intended to suggest any limitation as to the scope of use or functionality of the present invention. Neither should networking architecture 200 be interpreted as having any dependency or requirement related to any single component or combination of components illustrated therein.

Network 210 may include any computer network or combination thereof. Examples of computer networks configurable to operate as network 210 include, without limitation, a wireless network, landline, cable line, fiber-optic line, local area network (LAN), wide area network (WAN), metropolitan area network (MAN), or the like. Network 210 is not limited, however, to connections coupling separate computer units. Rather, network 210 may also comprise subsystems that transfer data between servers or computing devices. For example, network 210 may also include a point-to-point connection, the Internet, an Ethernet, a backplane bus, an electrical bus, a neural network, or other internal system.

In an embodiment where network 210 comprises a LAN networking environment, components are connected to the LAN through a network interface or adapter. In an embodiment where network 210 comprises a WAN networking environment, components use a modem, or other means for establishing communications over the WAN, to communicate. In embodiments where network 210 comprises a MAN networking environment, components are connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

The search-engine server 204, the web server A 206, and the web server N 208 may include any type of application server, database server, or file server configurable to perform the methods described herein. In addition, each of the search-engine server 204, the web server A 206, and the web server N 208 may be a dedicated or shared server. One example, without limitation, of a server that is configurable to operate as the search-engine server 204, web server A 206, and web server N 208 is a structured query language (“SQL”) server executing server software such as SQL Server 2005, which was developed by the Microsoft® Corporation headquartered in Redmond, Wash.

Components of the search-engine server 204, the web server A 206, and the web server N 208 may include, without limitation, a processing unit, internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer-storage media and communication media. In general, communication media enables each server to exchange data via network 210. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

While the search-engine server 204 is illustrated as a single box, one skilled in the art will appreciate that the search-engine server 204 is scalable. For example, the search-engine server 204 may in actuality include 100 servers in communication. The single unit depictions are meant for clarity, not to limit the scope of embodiments in any form.

In operation, the search-engine server 204 hosts a search engine designed to receive queries from remote computing devices (such as the client computing device 202) and locate information on the Web or within a private network to satisfy the queries. A query may consist of a request for information on the Web or private network that contains specific keywords or phrases. In addition, a query may include user-specified indications to only search particular types of web resources. In some embodiments, the search engine executing on the search-engine server 204 uses regularly updated indexes, which are created by web crawlers, to quickly locate web pages satisfying a query. Once the web pages are located, their URIs are transmitted back to the client computing device 202 and displayed as hyperlinks thereon. To access a located web page, a user need only select the corresponding hyperlink. One skilled in the art will appreciate that various other techniques exist for mining information on the Web or a private network.

Web pages are stored on the various web servers (e.g., the web servers A 206 and N 208) and accessible via the network 210 using a transfer protocol and relevant URI. The client computing device 202 may fetch a web page by requesting the URI using the transfer protocol. As a result, the web page can be downloaded to the client computing device 202 and stored in memory. The stored web page can then be read by the web browser 212 and presented to a user.

The client computing device 202 may be any type of computing device, such as device 100 described above with reference to FIG. 1. By way of example only but not limitation, the client computing device 202 may be a personal computer, desktop computer, laptop computer, handheld device, cellular phone, digital phone, smartphone, PDA, or the like. But it should be noted that embodiments are not limited to implementation on such computing devices.

Specifically, the client computing device 202 comprises a web browser 212. The web browser 212 is a software application enabling a user to display and interact with information located on the Web. In an embodiment, the web browser 212 communicates with the search-engine server 204, the web server A 206, and the web server N 208, using a transfer protocol to fetch web pages. Web pages may be located by the web browser 212 by sending the transfer protocol and the URI. The web browser 212 may use other URI types and protocols, such as file transfer protocol (FTP), real-time streaming protocol (RTSP), etc. The web browser 212 can also execute a number of markup languages (e.g., hypertext markup language (HTML) and extensible markup language (XML)) as well as scripting languages (e.g., JavaScript or Visual Basic Scripting Edition (VBScript)).

In operation, the web browser 212 submits a search-engine query entered by the user to the search-engine server 204. In one embodiment, the query includes a designation to only search for keywords in particular types of web resources, such as documents indexed as news articles. Using any number of well-known techniques, the search engine locates web resources that fit the query submitted by the user. For example, a request for news regarding inflation may return several different online articles discussing the subject. Hyperlinks of relevant web pages are returned to the client computing device 202 and arranged in a results page by the web browser 212.

In one embodiment, the results page contains at least two different display portions. One displays a list of hyperlinks—and possibly textual excerpts describing the web pages indicated by the hyperlinks—returned by the search-engine server 204 in response to the search-engine query. The user can select any of the results in the list for viewing in the second portion of the results page (referred to herein as the viewing frame). Once a result's hyperlink is selected, the web browser 212 submits a request for the corresponding web page. This may be done using any well-known transfer protocol (e.g., HTTP, FTP, etc.). In response, the requested web page is downloaded from a web server (e.g., the web server A 206 or the web server N 208) to the web browser 212. The web browser then displays the downloaded web page in the viewing frame.

The results page, which is a web page itself, is configured to display both the results list and the viewing frame. In some embodiments, the results page is encoded with various HTML tags to display both. Other software languages may also be used to create the results page (e.g., JavaScript or any of the aforementioned scripting languages).

In one exemplary embodiment, “frameset” tag divides the results page into multiple portions. A frameset tag is an HTML tag that can instruct the web browser 212 to arrange the content of the results page in a particular way. In another embodiment, an “href” tag is used to retrieve a search result selected by the user, and a “framesrc” tag is used to render the retrieved web page in the viewing frame. One skilled in the art will appreciate that other programming techniques may be used as well, and embodiments are not limited to the above HTML tags.

Users may not wish to view the selected result in the viewing frame; instead, they may desire to load a result in a new web-browser window. To enable such an option, icons may be positioned, in an embodiment, next to each hyperlink in the list of results. Each icon may be configured to retrieve an adjacent web resource and display it in a new web-browser window.

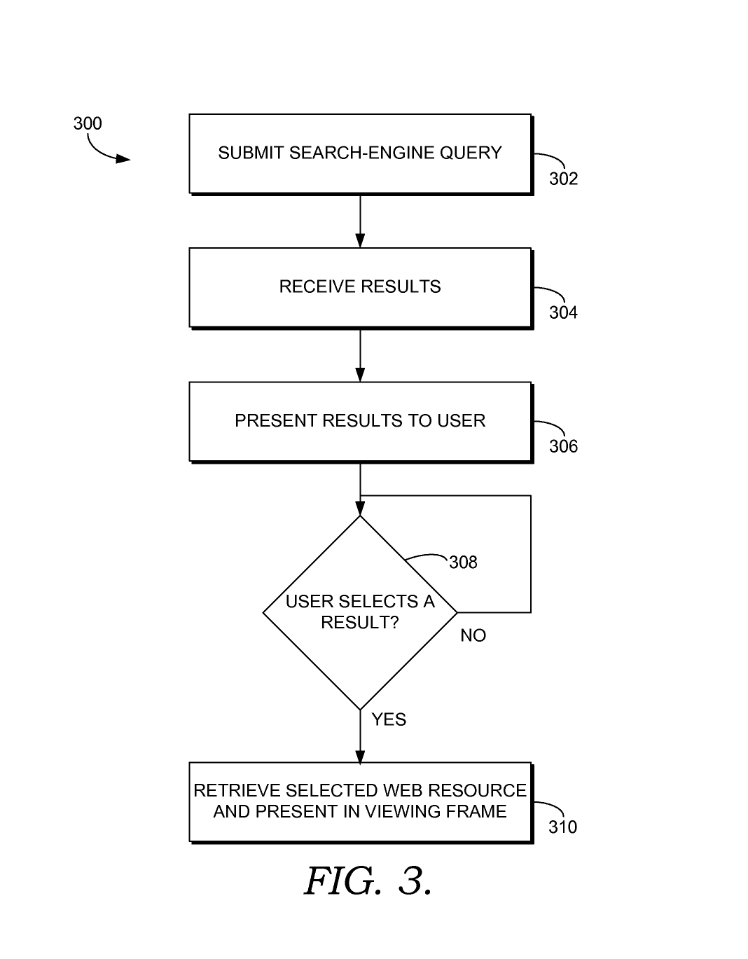

Turning now to FIG. 3, a flowchart is shown illustrating a process 300 for displaying a list of search-engine results in the same web-browser window as a presentation of one of the results, according to embodiments of the present invention. Initially, a search-engine query is submitted to the search-engine server 204, as indicated at block 302. The query may be initiated by a user entering keywords in a search-engine web page. Along with keywords, the search-engine query may also include an indication to focus the query on a particular type of web resources (e.g., news, blogs, feeds, spaces, etc.). Once the search-engine server 204 receives the query, it queries one or more databases to locate web pages related to the keywords (and types of web resources, if applicable). Results are then passed back to the client computing device 202 where they can be displayed in a results page by the web browser 212, as indicated at blocks 304 and 306.

The results page comprises a frame that includes a list of the search results sent by search-engine 204 and a viewing frame that displays results within the list that have been selected by the user. When the user selects a result, indicated by the YES path stemming from block 308, the web resource indicated by the result is retrieved and presented in the viewing frame, as indicated at 310. The web resource can be retrieved by submitting a request for the URI of the result. In one embodiment, the viewing frame displaying the web resource is presented in the same web-browser window as the list of results. If the user subsequently selects a different result in the list, the newly selected result is retrieved and displayed in the viewing frame.

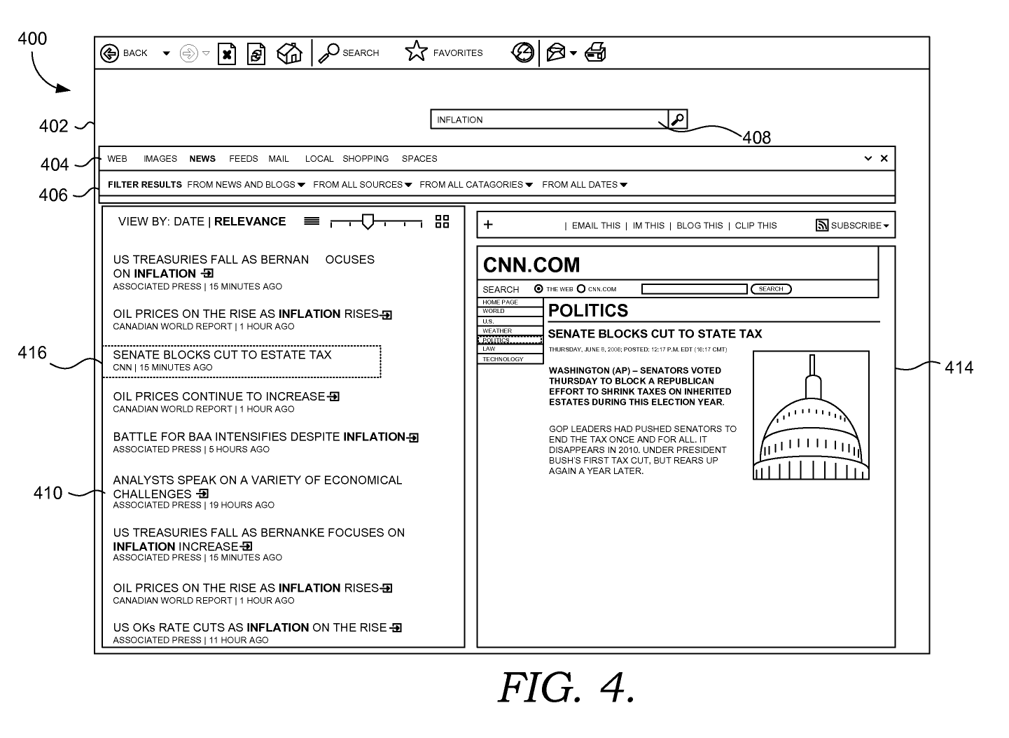

Turning now to FIG. 4, an exemplary display is shown of a GUI 400 for displaying a list of search-engine results in the same web-browser window as a presentation of one of the results, according to embodiments of the present invention. The GUI 400 depicts a web-browser window 402 displaying a results page after a search-engine query has been submitted. A user may submit the search-engine query by entering keywords into a text-entry field 408 and selecting a search icon (illustrated as a magnifying glass). In addition to keywords, the user may select a search filter 404 to focus the query on particular types of web resources.

The user may also select a results filter 406 that, in some embodiments, filters the results displayed in the list by a particular criteria. For example, the user may only wish to view news articles about the keywords from trusted news sources or blogs, within a given date, from a particular political view, etc. By selecting an option in the results filter, the web browser is configured, in some embodiments, to compare attributes of the results in the list and only display results that are in accordance with the criteria selected by the user.

In one embodiment, the results page comprises a list area 410, which contains a list of the results of the query, and a viewing frame 414. Hyperlinks and relevant text indicative of web resources may be included in the list. The user may select any of the links to view, and when he/she does, an indicator 416 (e.g., highlighting) may be applied to the selected link. Moreover, the selected link is retrieved and displayed in the viewing frame 414. Alternatively, the link may be presented in a new web-browser window if the user so chooses. Such a feature may be implemented by providing selectable icons next to each result in the list.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. A graphical user interface embodied on a computer-readable medium and executable on a computer, said graphical user interface comprising:
a first display area configured for displaying a list of one or more results of a search-engine query; and
a second display area configured for displaying a viewing frame that is configured to present a web resource associated with one of the one or more results of the search-engine query that has been selected by a user.

2. The graphical user interface of claim 1, wherein the search-engine query includes an indication originated by a user to focus the query on information associated with a particular type of web resource.

3. The graphical user interface of claim 2, wherein the particular type of web resource includes at least one of news, blogs, web feeds, or online spaces.

4. The graphical user interface of claim 1, wherein the first display area is configured to display one or more icons that, when selected by the user, retrieves and displays a result in a separate web-browser window.

5. The graphical user interface of claim 1, wherein the viewing frame is created by implementing a “frameset” tag in hypertext markup language.

6. The graphical user interface of claim 1, further comprising a third display area configured for displaying a text field that a user can enter one or more keywords for submission to a search engine.

7. The graphical user interface of claim 1, wherein the web resource is a news article.

8. The graphical user interface of claim 1, wherein the web resource is a web page.

9. The graphical user interface of claim 1, wherein the web resource comprises at least one of an audio clip, video clip, or image.

10. The graphical user interface of claim 1, further comprising a third display area configured for filtering the list of one or more results of the search-engine query so only results meeting a particular criteria are displayed.

11. In a computer system having a graphical user interface including a display and a user-interface selection device, a method for presenting a list of one or more results of a search-engine query in the same web-browser window as a viewing frame configured to present a web resource related to the one or more results, comprising:
submitting the search-engine query;
receiving the one or more results, wherein the one or more results include at least one hyperlink;
presenting the one or more results in a web page, wherein the web page comprises an area for displaying the list of one or more results of the search-engine query and a viewing frame for displaying a retrieved web page (306);
determining whether a user selects a result; and
incident to the user selecting the result, presenting a web resource associated with the result in the viewing frame.

12. The method of claim 11, further comprising receiving an indication to open the result in a new web-browser window.

13. The method of claim 12, wherein the indication is a user selection of an icon positioned adjacent to the result.

14. The method of claim 11, wherein the results page includes one or more icons configured to, when selected by the user, retrieve an associated web resource and display the associated web resource in a new web-browser window.

15. The method of claim 11, wherein the search-engine query comprises keywords associated with online news articles.

16. The method of claim 11, further comprising filtering the one or more results of the search-engine query by a criteria selected by a user.

17. The method of claim 16, wherein the criteria include blogs.

18. One or more computer-readable media having computer-executable instructions embodied thereon for presenting a list of one or more results of a search-engine query for news articles in the same web-browser window as a viewing frame configured to present a web resource related to the one or more results, comprising:
receiving the one or more results, wherein the one or more results include at least one hyperlink; and
presenting a web resource associated with the one or more results in a viewing frame of a web page, wherein the web page presents the viewing frame in the same web-browser window as the list of one or more results.

19. The one or more computer-readable media of claim 18, wherein each of the one or more results are displayed on the web page next to one or more icons that, when selected by the user, will initiate the display of one or more web resources in a new web-browser window.

20. The one or more computer-readable media of claim 18, further comprising applying an indication to one of the one or more results selected by a user.
